(19) United States
(12) Patent Application Publication
(10) Pub. No.: US 2004/0119241 A1
(43) Pub. Date: Jun. 24, 2004

(54) Cartridge seal assembly

(76) Inventor: Larry J. Castleman, New Haven, IN (US)

Correspondence Address: RANDALL J. KNUTH P.C., 3510-A STELLHORN ROAD, FORT WAYNE, IN, 46815-4631, US

(21) Appl. No.: 10/673,764

(22) Filed: Sep. 26, 2003

Related U.S. Application Data
(60) Provisional application No. 60/428,111, filed on Nov. 21, 2002.

(51) Int. Cl. F16J 15/32; F02F 5/00

(52) U.S. Cl. 277/436; 277/549

(57) ABSTRACT

A cartridge seal assembly includes a cylindrical housing having a shaft-receiving channel formed therethrough to define an inner annular surface. A sleeve bearing is joined to the housing at the inner annular surface. The mounting relationship of the bearing to the housing is configured to eliminate extrusion gaps, such as with a bonding attachment. As a results, the seals can be located immediately adjacent to the joint line. A pair of annular seal elements are joined to the housing and located within respective annular grooves formed in the housing at opposite sides of the bearing. A first seal located at the high pressure end of the assembly includes static and dynamic sealing areas. A portion of the static sealing area extends past the radially outermost surface of the housing to define a circumferential seal relative to the system housing. The second seal is configured as a wiper device.

### PRIORITY DATA

This application hereby claims the benefit under Title 35, United States Codes § 119(e) of the U.S. application Ser. No. 60/428,111 filed Nov. 21, 2002, and is hereby incorporated by reference.

### BACKGROUND OF THE INVENTION

1. Field of the Invention

The present invention relates to a sealing apparatus, and, more particularly, to a cartridge-type seal assembly providing bearing support and a static and dynamic sealing action.

2. Description of the Related Art

Conventional seals for mechanisms such as shafts and rods typically are configured within annular grooves formed in a housing unit. In various forms, the seals are typically not secured in such a fashion as to prevent unitary movement or displacement, which places demands and constraints on dimensional tolerances in other areas of the unit in order to accommodate such whole seal movement.

Furthermore, conventional systems typically are characterized by an undue amount of interstitial spaces and clearances. For example, conventional bearing structures often have an appreciable clearance area between its outer surface and the opposing inner surface of the surrounding housing. However, problems arise because this clearance area affords seals the opportunity to enter these clearances and undergo extrusion. For these reasons, particularly the extrusion gap, it has not been possible in conventional designs to intimately integrate sealing systems with bearing devices.

### SUMMARY OF THE INVENTION

According to the present invention, there is provided a cartridge seal assembly providing bearing support and/or sealing activity to a working element. For example, in one application, the cartridge seal assembly may receive the piston rod of a hydraulic piston-cylinder combination. The assembly includes an elongate housing structure having a bore or shaft-receiving channel formed therethrough to define an inner annular surface. An sleeve-type bearing having an annular shape is joined to the housing at the inner annular surface.

In one form, the bearing is mounted to the housing in a fixed relationship, namely, there is no relative movement between the housing and bearing, either translational (e.g., axial or radial) or rotary. It may then be considered that the bearing and housing have a static relationship. As such, the bearing may be considered to be a stationary or non-floating element. A preferred joining technique involves bonding the bearing to the housing.

The joint established by engagement of the bearing to the housing is preferably characterized by a substantially gap-free or clearance-free interface between the components. In one form, the bearing is mounted to the housing in a fixed, surface-to-surface contacting engagement. The bearing-housing joint is developed with a view towards providing an interface that is substantially free of any extrusion gaps, a notable advantage over conventional systems. Overall, the cartridge seal assembly is constructed with a view towards eliminating or optimally minimizing the clearance spaces or open areas existing between the seal and bearing components and neighboring parts or surfaces.

The cartridge seal assembly further includes a sealing system. In one form, a pair of seals are disposed axially of the bearing and joined to the housing. For example, a first and second seal are located within annular grooves formed at opposite ends of the housing. A first annular seal disposed at a high pressure end of the assembly includes a static sealing area and a dynamic sealing area. A second annular seal disposed at a comparatively low pressure end of the assembly includes a wiper-type device.

In one form, the static sealing area of the first seal includes an integral finger portion and a terminal lip portion. The finger portion extends radially outward away from the groove and along an end surface of the housing. The lip portion extends at least immediately past the plane of the outer diameter surface, e.g., along the corner peripheral edge of the housing and along the radially outermost surface of the housing.

The combination of the finger portion and lip portion of the first seal cooperatively defines an uninterrupted sealing surface that covers the entire axially-facing end surface areas of the cartridge seal assembly. Moreover, the lip portion has a radial extent sufficient to form a compressive seal with the inner diameter surface of the field device, e.g., the cylinder housing of a piston-cylinder combination. As a result, a circumferential seal is formed about the housing with respect to the immediately neighboring opposing surface of the cylinder, for example.

In one form, the dynamic seal area of the first seal faces generally radially inward and includes a contoured profile having a surface geometry that defines at least one circumferential contact sealing line. The dynamic seal area preferably includes multiple sections of different radial penetration to provide various pressure-related sealing lines.

In another form, the first seal includes a body portion and a pair of leg portions extending therefrom in different generally radially directions to define a generally Y-shaped cross-sectional seal configuration. The generally concave curvature formed at the juncture of the leg portions enhances the sealing action of the dynamic seal area, since during high pressure conditions the leg portion proximate the dynamic seal area responds under the high pressure to displace radially inward and further compress the dynamic seal area against the piston.

The second seal includes a wiper arm that extends radially inward and axially outward. The wiper arm terminates with a wiping edge that engages and performs a wiping action on the piston rod during piston reciprocation, for example.

The cartridge seal assembly can be configured so that the seals and bearing are bonded to the housing. Alternately, some or all of these components can be removably mounted to the housing to facilitate replacement of individual parts. A preferred configuration would employ a bonded bearing and unbonded seals, e.g., removably attached to the housing.

The invention, in one form thereof, is directed to a cartridge seal assembly comprising, in combination, a housing having a channel space formed therein to define an inner surface; a bearing device joined to the housing at the inner surface thereof and having at least one bearing surface; and at least one seal joined to the housing. At least one of the seals is disposed generally axially of at least part of the bearing device.

In one form, the bearing device and/or at least one of the seals is bonded to the housing. In another form, the bearing device is fixedly mounted to the housing. In a further form, the joining relationship between the bearing device and the housing is defined by a substantially gap-free interface. Furthermore, the joining interface between the housing and the bearing device is substantially free of extrusion gaps.

In one configuration, the seal arrangement includes a first generally annular seal disposed at one axial side of the bearing device. The first seal includes at least one static sealing area and/or at least one dynamic sealing area. A second generally annular seal is disposed at another axial side of the bearing device and includes a wiper element.

In one form, the static sealing area of the first seal further includes a first static sealing portion extending generally radially along a generally axially-facing end surface of the housing, and a second static sealing portion engaging the first static sealing portion and extending at least in part immediately past the axial plane of an outer radial surface of the housing. Moreover, the first seal is preferably made of a compressible material and is sufficiently formed such that during operative field installation as the second static sealing portion engages an opposing surface of a field device and thereby experiences compression, the compressed second static sealing portion forms a substantially fluid-tight seal circumferentially about the housing between the outer radial surface of the housing and the field device.

In one form, the dynamic sealing area further includes a surface contour or geometry that extends (in part) radially inward at least to the plane of the bearing surface of the bearing device to define at least one sealing line.

In another form, the seal arrangement includes a generally annular seal portion circumferentially disposed at least in part about the housing.

In another form, the seal arrangement includes a first generally annular seal disposed at least in part within a first groove defined in the housing at one axial side of the bearing device, and a second generally annular seal disposed at least in part within a second groove defined in the housing at another axial side of the bearing device. In one configuration, the first seal includes a static sealing area and/or a dynamic sealing area, and the second seal defining a wiper configuration.

In an alternate configuration, the bearing device and/or at least one of the seals is removably joined to the housing.

The invention, in another form thereof, is directed to a cartridge seal assembly comprising, in combination, a housing having a channel space formed therein to define an inner surface, a bearing device joined to the housing at the inner surface thereof and having at least one bearing surface, and a first generally annular seal disposed generally axially of the bearing device and joined to the housing. The first seal includes a static sealing area and/or a dynamic sealing area.

In one form, at least one of the bearing device and the first seal is bonded to the housing. The joining interface between the housing and the bearing device is defined to be substantially free of extrusion gaps.

In another form, the assembly includes a second generally annular seal disposed generally axially of the bearing device and axially opposite the first seal. The second seal is joined to the housing and includes a wiper element.

In another form, the bearing device is disposed at a generally axially central location of the housing, and each of the first and second seals is disposed in respective grooves formed in the housing at opposite sides of the housing central location. The seals are bonded to the first housing portion.

In another form, the static sealing area of the first seal includes a generally annular seal circumferentially disposed at least in part about the housing.

The invention, in another form thereof, is directed to a cartridge seal assembly including, in combination, a housing having a channel space formed therein to define an inner surface, and a bearing device joined to the housing at the inner surface thereof and having at least one bearing surface. The housing further includes a first generally annular groove and a second generally annular groove defined at respective sides of the housing. A first generally annular seal is disposed at least in part within the first groove of the housing and joined thereto. A second generally annular seal is disposed at least in part within the second groove of the housing and joined thereto.

In one form, at least one of the bearing device, the first seal, and the second seal is bonded to the housing. Alternately, at least one of the bearing device, the first seal, and the second seal may be removably joined to the housing.

In another form, the first seal includes a static sealing area and/or a dynamic sealing area, and the second seal including a wiper configuration.

The assembly further includes a generally annular seal portion circumferentially disposed at least in part about the housing.

The invention, in another form thereof, is directed to a cartridge seal assembly including a housing having a receptacle channel formed therethrough; a first means joined to the housing, the first means to define a bearing surface within the receptacle channel; and a seal system having at least one seal, the seal system being joined to the housing.

In one form, the first means includes a portion of the housing. Alternately, the first means can include a bearing device joined to the housing at an inner surface defined by the receptacle channel.

In another form, the bearing device and/or at least one seal of the seal system is bonded to the housing. Furthermore, the joining relationship between the bearing device and the housing is defined by a substantially gap-free interface inhibiting extrusion.

In another form, the seal system further includes a first generally annular seal bonded to the housing, wherein the first seal includes a static sealing area and/or a dynamic sealing area; and a second generally annular seal bonded to the housing, wherein the second seal includes a wiper configuration.

The invention, in another form thereof, is directed to an apparatus comprising, in combination, a housing having a receptacle channel formed therethrough to define an inner housing surface; a bearing device bonded to the housing at the inner housing surface; and at least one seal joined to the housing.

In one form, the seals are bonded to the housing.

In another form, the seal include a first generally annular seal having a static sealing area and/or a dynamic sealing area; and a second generally annular seal having a wiper element. Furthermore, the seals may include a seal circumferentially disposed at least in part about the housing.

The invention, in another form thereof, is directed to a method of producing a cartridge seal assembly. The method involves providing a housing having a channel space formed therethrough to define an inner surface; bonding a bearing structure to the inner surface; and joining at least one seal to said housing.

In one form, the seals are bonded to the housing.

The invention, in yet another form thereof, is directed to a method of producing a cartridge seal assembly. The method involves providing a housing having a channel space formed therethrough to define an inner surface; joining a bearing structure to the inner surface to define a joining interface therebetween being substantially gap-free; and joining at least one seal to said housing.

In one form, the bearing structure is bonded to the housing.

One advantage of the present invention is that the cartridge seal assembly is provided as a unitary, fully-integrated, and field-ready device that can be installed as-is into the field application environment without the need for any user reconfiguration, assembly, or retrofitting.

Another advantage of the invention is that alternate modular configurations of the cartridge seal assembly can offer replacement of individual parts, such as by removably mounting the bearing and/or seals to the housing.

Another advantage of the invention is that the cartridge seal assembly integrates the functionality of bearing support and sealing protection into a single unified construction fully ready for installation.

Another advantage of the invention is that the cartridge seal assembly combines the functionality of bearing support and sealing action into a single design architecture without compromising the benefits of either the seal or bearing, while overcoming the conventional problems associated with their interaction, particularly in regard to extrusion problems.

Another advantage of the invention is that the cartridge seal assembly can be manufactured to permanently join the seals to the housing unit and thereby improve its sealing integrity and provide a fully functional “drop-in” unit.

Another advantage of the invention is that the seals are retained and secured in such a fashion (e.g., bonded to the housing) that gives the sealing areas the freedom to compress and flex in order to perform their expected functions, but inhibits unitary movement or displacement of the seals.

Another advantage of the invention is that the sealing arrangement provides both a static sealing area and a dynamic sealing area, thereby improving the sealing efficiency of the cartridge seal assembly across its spectrum of operating states, e.g., cyclical pressure changes between a high pressure and a low pressure condition.

Another advantage of the invention is that the as-installed sealing arrangement provides a full-coverage, omni-directional sealing action in terms of presenting a sealing surface throughout the entire interior cross-sectional plane surrounding the moving part, e.g., piston.

Another advantage of the invention is that the sealing arrangement not only provides sealing with respect to the actuating part (e.g., piston), but also provides sealing with respect to the outermost interior dimensions of the field device that houses the actuating part (e.g., cylinder).

Another advantage of the invention is that the unitary construction of the cartridge seal assembly facilitates quick replacement since a new unit can simply be substituted for the old unit without any user modifications, thereby fostering faster repair of the equipment.

Another advantage of the invention is that the cartridge seal assembly can be reused in other application environments having compatible working specifications, e.g., a piston rod and housing cylinder with similar dimensions.

Another advantage of the invention is that the use of a single bearing at a central axial location relative to the end seals provides a symmetrical arrangement exhibiting bearing distribution and bearing area balance, which favorably changes the distribution of the lateral load forces on the bearing surfaces relative to conventional designs having multiple spaced-apart bearings interspersed along the axial dimension.

Another advantage of the invention is that the cartridge seal assembly has a design characterized by reduced and/or eliminated extrusion gaps relative to conventional apparatus; for example, the configuration of the seal members relative to the housing and bearing device exhibit minimal or practically non-existent opportunities for the seals to experience extrusion.

Another advantage of the invention is that the relative ease in installing and replacing the cartridge seal assembly due to its fully-integrated modular form facilitates rapid servicing of the system environment.

Another advantage of the invention is that the bearing structure is directly mounted to the inner surface of the housing to facilitate the elimination of extrusion gaps at the attachment surface of the bearing, which distinguishes from conventional designs where the bearing is located within a groove but possesses an undesirable clearance with the surrounding groove seat that fosters seal extrusion.

Another advantage of the invention is that elimination of a gap between the housing and bearing reduces and simplifies the tolerance requirements of the thin-film clearance area between the bearing inner diameter and shaft outer diameter, enabling formation of a more stable, consistent, and uniform hydraulic thin-film bearing effect.

Another advantage of the invention is that elimination of the bearing-housing extrusion gap means that there are no extrusion-related concerns or limitations regarding the geometry and location of the seals vis-a-vis the bearing-housing interface, thereby providing greater design freedom and flexibility in the arrangement and configuration of the sealing environment.

### BRIEF DESCRIPTION OF THE DRAWINGS

The above-mentioned and other features and advantages of this invention, and the manner of attaining them, will become more apparent and the invention will be better understood by reference to the following description of an embodiment of the invention taken in conjunction with the accompanying drawings, wherein:

FIG. 1 is a cross-sectional schematic view depicting an illustrative installation configuration for a cartridge seal assembly, according to one form of the invention;

FIG. 2 is a partial axial cross-sectional schematic view of a cartridge seal assembly, according to another form of the invention;

FIG. 3 is a partial axial cross-sectional schematic view of the housing and bearing structure for use in the cartridge seal assembly of FIG. 2;

FIG. 4 is an axial end view of the housing and bearing structure depicted in FIG. 3;

FIG. 5 is an axial end view of the cartridge seal assembly depicted in FIG. 2 for comparison with FIG. 4;

FIG. 6 is a cross-sectional view of one form of the invention, similar to FIG. 2;

FIG. 7 is a cross-sectional view of a prior art seal assembly;

FIG. 8 is a cross-sectional view of one form of the present invention, improving upon the seal assembly of FIG. 7;

FIG. 9 is a cross-sectional view of another prior art seal assembly;

FIG. 10 is a cross-sectional view of one form of the present invention, improving upon the seal assembly of FIG. 10;

FIG. 11 is a cross-sectional view of another prior art seal assembly; and

FIG. 12 is a cross-sectional view of one form of the present invention, improving upon the seal assembly of FIG. 11.

Corresponding reference characters indicate corresponding parts throughout the several views. The exemplification set out herein illustrates one preferred embodiment of the invention, in one form, and such exemplification is not to be construed as limiting the scope of the invention in any manner.

### DETAILED DESCRIPTION OF THE INVENTION

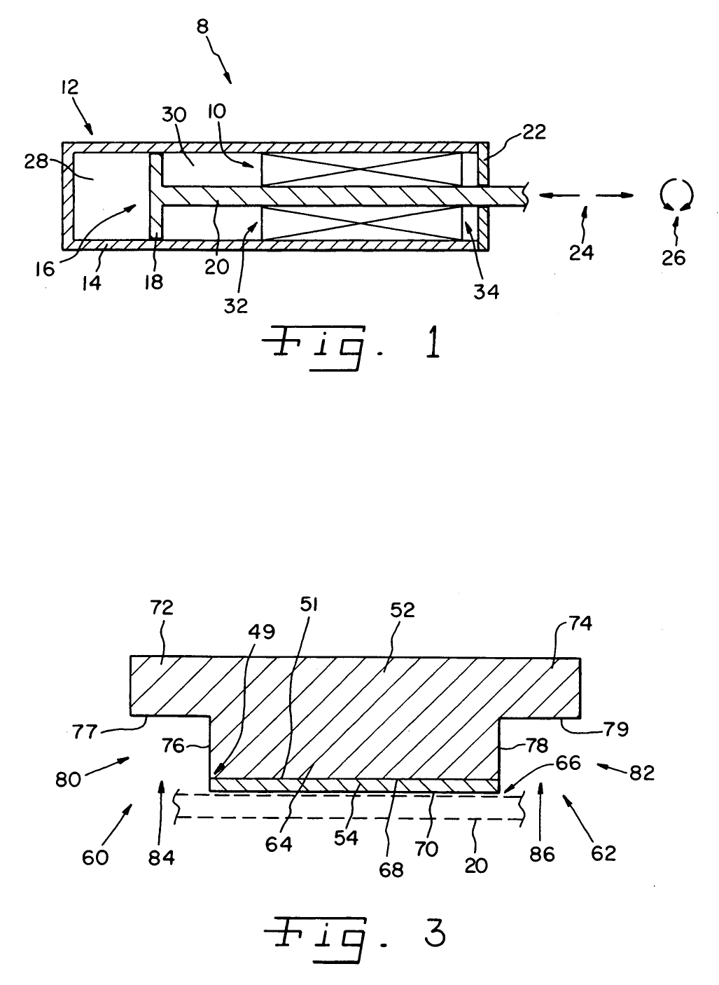

Referring now to the drawings and particularly to FIG. 1, there is shown a schematic cross-sectional view of an application environment 8 to illustrate one possible installation or working scenario for the cartridge seal assembly of the invention (shown generally in representative schematic form at 10).

As shown, the illustrated application environment 8 includes a hydraulic piston-cylinder combination 12 having a cylinder 14 and a piston 16 with head portion 18 and rod portion 20. A cover plate 22 closes one end of piston-cylinder combination 12 and include a port or opening through which rod 20 passes. In conventional manner, rod 20 may be connected to other machinery to accomplish certain driving and actuating functions known to those skilled in the art.

The cartridge seal assembly of the invention depicted representatively at 10 defines a structure that provides bearing support and sealing activity to piston rod 20 passing therethrough, according to one form of the invention.

Although cartridge seal assembly 10 has been shown in connection with a field installation involving a piston-cylinder combination, this configuration is provided for illustrative purposes only and should not be considered in limitation of the present invention. Rather, it should be apparent that the invention may be practiced in other application environments to provide sealing and bearing support to mechanisms other than pistons, such as rods, shafts, and other similar structures.

Additionally, the invention may be practiced with piston-cylinder combinations other than that shown in FIG. 1. Accordingly, the invention should not be limited by technical features of the mechanism or apparatus with which the cartridge seal assembly of the invention works. Furthermore, the invention should not be limited to the operating principles of the working environment. For example, the invention may be practiced in environments where hydraulic power actuates piston 16, or environments where other drive mechanisms such as a motor apparatus are used to power piston 16. For example, a motor may be used to actuate rotary movement of a shaft received within the cartridge seal assembly.

Moreover, the invention may be practiced in application environments where the element received within the cartridge seal assembly may undergo linear and/or rotary movement. For example, piston rod 20 can be configured as known to axially reciprocate (e.g., a left-right motion in the drawing as shown by directional arrows 24), or rotate (as shown by arrows 26).

Referring still to FIG. 1, the illustrated piston-cylinder combination 12 further includes first and second variably pressurizable chambers 28 and 30, respectively. In one form, for example, the chambers are sealed off from one another by conventional means in order to develop a pressure differential therebetween to facilitate actuation of piston 16. Alternately, the chambers may be connected and thereby maintained at equivalent pressures.

During operation of piston-cylinder combination 12, for example, the mechanism for retracting or withdrawing piston rod 20 back into cylinder 14 conventionally employs a pressure differential wherein chamber 30 is maintained at a pressure level higher than chamber 28. Accordingly, with respect to cartridge seal assembly 10, it is considered in one form of the invention that one axial end 32 of assembly 10 is the comparatively high-pressure end while the other opposite axial end 34 of assembly 10 is the comparatively low-pressure end.

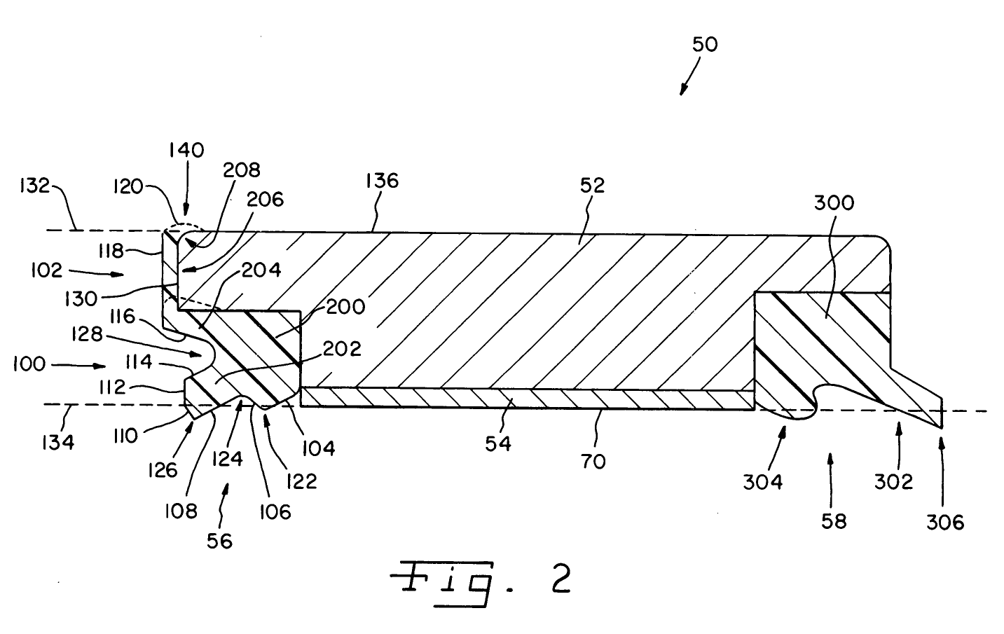

As used herein, references to “axial” or “axially” should be understood as referring to a direction or dimension generally in the same direction as the principal, major, and/or longitudinal axis of the cartridge. For example, in a field system utilizing a piston-cylinder combination, the axial direction will typically correspond to the longitudinal dimension of the piston rod. In FIG. 2, the axial dimension is right-left.

As used herein, references to “radial” or “radially” should be understood as referring to a direction or dimension generally perpendicular or transverse to the principal axial dimension of the cartridge seal assembly of the invention. For example, in FIG. 2, the radial direction is up-down.

Referring now to FIG. 2, there is shown a partial axial cross-sectional schematic view of a cartridge seal assembly 50 such as assembly 10 in FIG. 1, according to one form of the invention. The view depicts a half section of the full cartridge seal assembly.

The illustrated cartridge seal assembly 50 includes a housing structure 52, a bearing structure 54, a first generally annular or generally ring-shaped seal member 56 disposed at one end of housing 52, and a second annular or ring-shaped seal member 58 disposed at another end of housing 52.

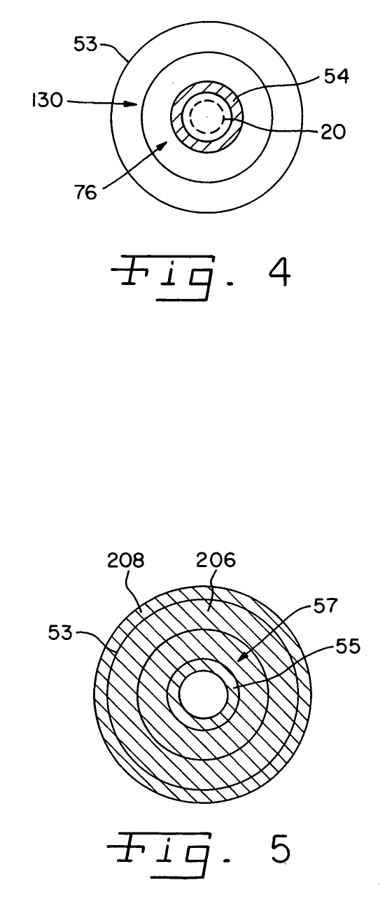

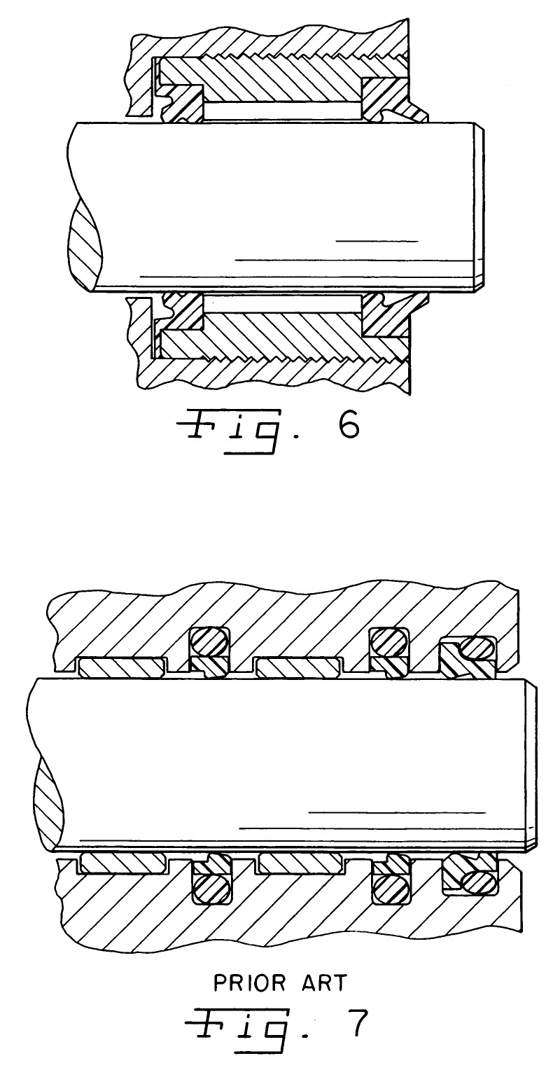

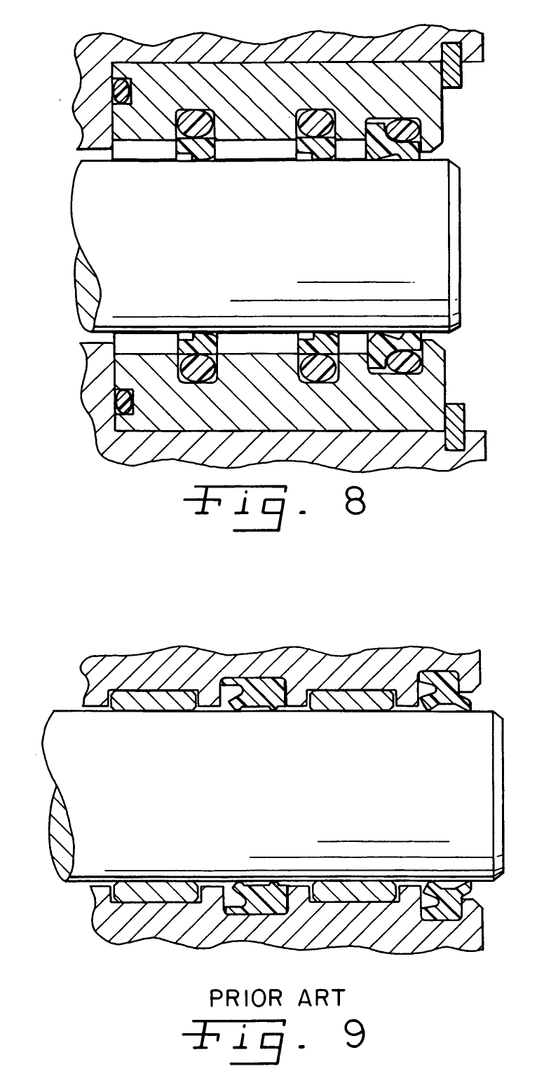

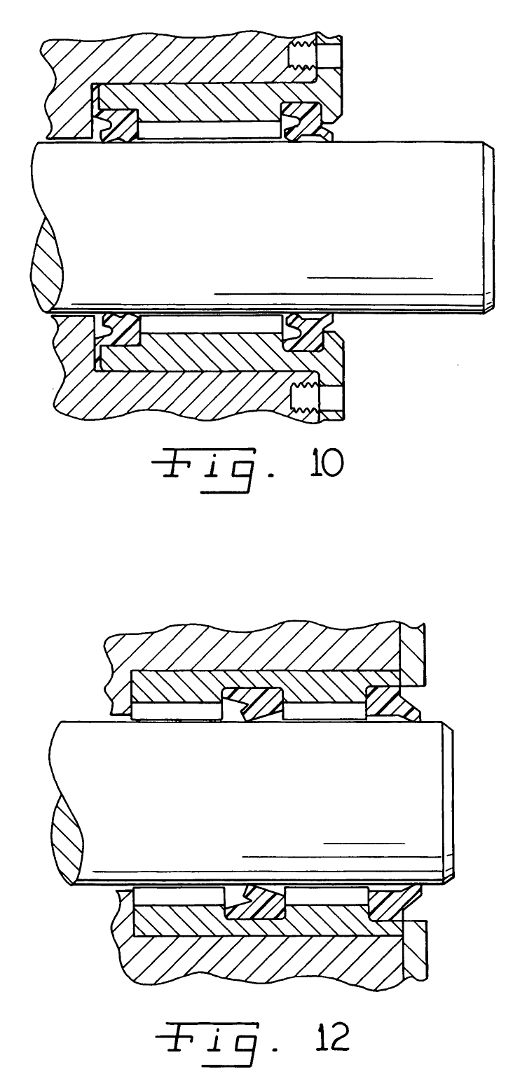

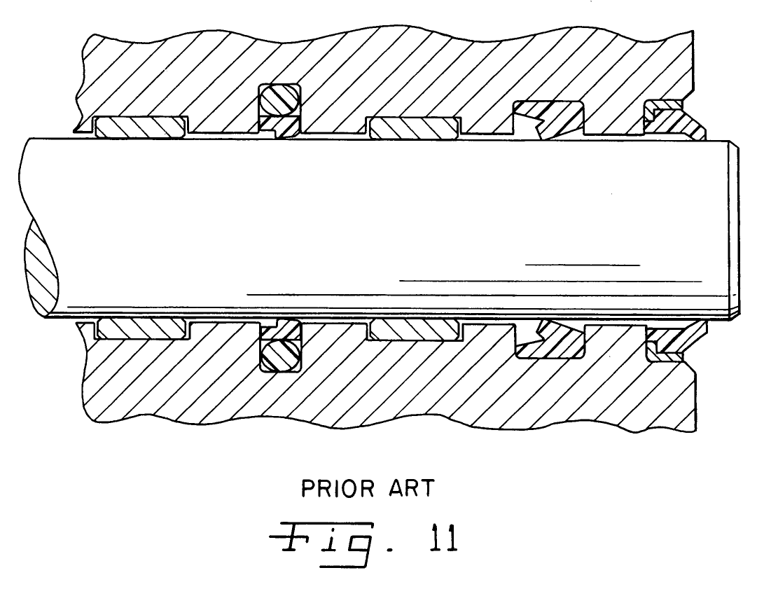

Referring briefly to FIGS. 3 and 4, there is shown in FIG. 3 a partial axial cross-sectional schematic view of housing 52 and bearing 54 from FIG. 2. FIG. 4 depicts a full axial end view of the combined housing and bearing structure shown in FIG. 3, taken at the front end, i.e., the housing end proximate seal 56. The installed relationship between housing 52 and bearing 54 vis-a-vis the supported element is shown, for example, by the phantom outline of exemplary piston rod 20.

For purposes herein, and for discussion purposes only, a piston rod will be designated as the element received by the cartridge seal assembly of the invention, although it should be understood that such reference to the piston rod is equally applicable to any other structure received by the cartridge seal assembly.

In one form, housing 52 has an elongate right-cylindrical or tubular shape having a generally central bore defined therethrough to receive the housed element, such as piston rod 20. Accordingly, the geometrical specifications of housing 52 will accord with the dimensions of the piston rod (or other housed element). For example, the overall dimensions of the cartridge seal assembly, and particularly housing 52, will accord with the desired thickness of bearing 54 and the desired thickness of the hydraulic thin film formed in the interstitial circumferential space operatively defined between the inner diameter of bearing 54 and the outer diameter of rod 20 (indicated generally at 66).

It should be apparent that any suitable shape of housing 52 can be used in the practice of the invention. For example, housing 52 can be shaped as a prism, e.g., a right-rectangular structure, with the interior sufficiently formed to accommodate rod 20. Typically, the outer dimensions of housing 52 will be sized and dimensioned according to the interior dimensions of the field device into which the cartridge seal assembly is installed. Similar accommodations are made as to the length of housing 52, such as the required axial length of bearing 54 and the number and size of the seals.

Housing 52 includes a generally central body or bearing support portion 64. The illustrated bearing support portion 64 includes an inner annular mounting surface 68 that defines a bore-type receptacle (e.g., circular space) that slidingly receives rod 20 extending therethrough during field use. Mounting surface 68 preferably defines the innermost diameter of housing 52. Housing 52 also includes projecting ledges or cantilever portions 72 and 74 extending from body portion 64 that are defined by the formation of annular grooves 60 and 62, respectively.

As shown, bearing 54 is mounted at its outer diameter surface to housing 52 at mounting surface 68. In one form, bearing 54 is a sleeve-type design having an inner diameter surface 70 facing radially inward and serving as the bearing surface relative to rod 20. However, bearing 54 can have any suitable geometry as determined in a manner known to those skilled in the art. Additionally, the criteria for determining the longitudinal extent of bearing 54 is well within the knowledge of one skilled in the art and may be dictated by various known factors, such as the desired degree of axial bearing support.

According to one advantageous feature of the invention, the joining relationship between housing 52 and bearing 54 is developed with a view towards addressing and eliminating the conventional problems associated with undesirable extrusion gaps.

Briefly, by way of overview, conventional bearing designs employ a bearing device typically installed in a groove. However, the bearing itself is ordinarily not bonded or mounted in a fixed relationship to the groove. Essentially, the bearing is allowed to “float.” As a result, an annular gap exists between the outer diameter (OD) of the bearing and the inner diameter (ID) of the surrounding groove.

In order to accommodate this floating property, conventional designs require that a corresponding compensation gap exist on the other side of the bearing between the inner diameter surface of the bearing and the outer diameter surface of the shaft. This compensation is done to account for movement or “floating” of the bearing in order to prevent the displaceable bearing from closing the separation gap with the supported device (e.g., piston shaft) and thereby contacting the shaft. Notably, this compensation space is in addition to whatever thin-film clearance is needed for lubrication and bearing effects.

The clear drawback of such a designed-in separation gap between the bearing OD surface and the groove ID surface is that nearby seals can extrude into this space, leading to seal deterioration and compromise of the sealing activity. The extrusion problem may impact seal design and arrangement since it can dictate that seals must be located sufficiently far from the extrusion gap or designed with a geometry that avoids the gap. However, having such a concern govern the location and design of seals is undesirable since it may lead to the seals being positioned in less optimal locations or manufactured with sub-optimal geometries.

Moreover, the conventional requirement for such a compensation gap means that the dimensional tolerances between the bearing ID surface and the shaft OD surface must be adjusted and changed commensurate with the amount of possible “floating” movements. Unfortunately, this compromises the important thin-film effect between the bearing and shaft.

Another limitation introduced by the presence of extrusion-related gaps is that the functionality of seals and bearings typically cannot be combined into a single integrated design, since the close proximity of seals to the bearing-housing interface can lead to extrusion problems. Thus, conventional designs typically exhibit a less than desirable spacing or physical separation of the seals and bearings to avoid extrusion. As a result, conventional design strategies find it difficult to provide compact units integrating both seal protection and bearing support.

According to the invention, however, these disadvantages are overcome by a design that altogether eliminates the floating behavior of the bearing and the attendant extrusion problems by fixedly mounting the bearing to the inner annular surface of the housing, in accordance with a substantially gap-free mounting relationship. Even in configurations where the bearing is removable, the bearing and housing are joined by a static connection characterized by the absence of relative movement between the parts and the elimination of any clearance separation between the bearing and housing.

Referring again to FIG. 3, the joint or interface 51 defined between bearing 54 (at the OD thereof) and housing 52 (at the ID thereof) is characterized by a gap-free engagement, in accordance with the invention. For example, the applicable mounting surfaces of bearing 54 and housing 52 may be joined (e.g., bonded) in a surface-to-surface, contact-type engagement.

Notably, at the axial end 49 of joint 51, there is no space available for a seal in groove 60 (i.e., seal 56) to experience extrusion. It then becomes possible to locate seals immediately adjacent to and even in intimate contact with the joint line, since no extrusion is possible. In particular, the seals can directly abut against or overlap the joint line without raising any extrusion issues. In contrast to conventional designs, there are then no limitations regarding either the location or geometry of the seals vis-a-vis the bearing-housing mating interface.

Furthermore, the elimination of the extrusion gap means that the cartridge seal assembly of the invention need not adopt the same tolerance criteria found in conventional designs. In particular, no compensation is needed at the circumferential location between the bearing ID surface and shaft OD surface, due to the absence of any bearing-type floating behavior. Therefore, the dimensional tolerances of this clearance space can attend exclusively to providing the most optimal hydraulic thin-film, addressing factors such as lubrication and hydraulic bearing support, for example.

Removal of the separation space between the bearing OD surface and the housing ID surface not only addresses the extrusion gap, but also eliminates the accumulation of debris and other foreign matter into this area. In conventional designs, it is inevitable that the extrusion gap also eventually collects debris that remains in the system and is difficult to flush out.

Notably, this problem is not present in the cartridge seal assembly of the invention since the area of the extrusion gap has been eliminated. Generally, it is an object of the invention to eliminate the free clearances and interstitial spaces between and among the components, namely, the bearing, housing, and sealing system. For example, in one form of the invention, both the sealing system and the bearing are bonded to the housing so that their respective mounting interfaces are virtually free of any problematic spacings. Not only does this promote positional, geometrical, and structural integrity in the overall architecture of the assembly, but it enables stable and reproducible operation of the assembly in terms of its bearing and sealing functions.

Any suitable means may be used to join the sealing system and bearing 54 to housing 52. As discussed above, an appropriate joining technology is preferably employed that fixes the connection relationship between the bearing and housing and ensures that there is no space between the bearing OD surface and the housing ID surface at the mounting interface therebetween.

The joining process may be accomplished using any suitable conventional means known to those skilled in the art. For example, a bonding process can be used, such as thermal, mechanical (e.g., T-slot, dovetail groove, circumferential hump on outer diameter of bearing), chemical (e.g., no adhesive—seal or bearing directly bonded chemically during the manufacture of seal or bearing), adhesive, or any combination thereof. Alternately, unbonded joining techniques can be utilized, which would facilitate removable mounting of the parts to improve serviceability of the system since repair tasks could involve replacement of individual parts instead of the entire unit.

Additionally, an injection molding process can be used. Bearing 54, in particular, can be molded or press fit. However, these examples should not be considered in limitation of the invention but merely illustrative, since other joining methods can be employed as would be apparent to one skilled in the art.

Returning to FIG. 3, the illustrated housing 52 includes first and second annular grooves or seal-receiving channels 60 and 62, respectively, formed at opposite axial ends of housing 52. As discussed further, annular grooves 60 and 62 receive first and second seals 56 and 58, respectively, at groove bottom seating surfaces 77 and 79. Accordingly, grooves 60 and 62 are suitably dimensioned to receive seals 56 and 58.

As shown, grooves 60 and 62 preferably are formed with an open-sided design having no sidewalls opposite axial sidewall surfaces 76 and 78, respectively. In particular, grooves 60 and 62 are respectively provided with axially-facing mouth portions 80 and 82 (opposite sidewall surfaces 76 and 78) and radially-facing mouth portions 84 and 86. However, this housing configuration is merely illustrative and should not be considered in limitation of the invention, as other groove configurations or seal-receiving spaces are possible depending upon the desired location, number, shape, and geometry of the seals.

As discussed further, the pair of seals 56 and 58 are shown for illustrative purposes only and should not be considered in limitation of the present invention, as any suitable sealing system can be used to practice the invention. For this purpose, then, housing 52 will be formed, machined, and otherwise constructed to accommodate the specific geometry and arrangement of the selected sealing system. It is well within the purview of one skilled in the art to tailor construction of the housing structure to the particular arrangement of seals.

As discussed yet further, the sealing system for practicing the invention may employ any number, geometry, arrangement, and orientation of seals within the cartridge seal assembly. Accordingly, the seal configuration in FIG. 2 should not be considered in limitation of the invention, but merely illustrative.

In one form, housing 52 is constructed such that bearing surface 68 is located centrally and symmetrically between grooves 60 and 62 to promote balance and to prevent rod 20 from rocking or levering inordinately into one of the seals due to undesirable lateral forces imposed on rod 20. The invention provides certain advantages regarding bearing distribution and bearing area balance, which concerns the axial location of the bearings relative to the seals.

In conventional designs, multiple bearings may be spaced upstream and downstream of the seals to provide protection against the rocking effect of lever forces generated by side loads at the end of the shaft. However, in the cartridge seal assembly disclosed herein, the single bearing design changes the distribution of the side load forces on the bearing surfaces to more stably and compactly counteract the lateral forces against the shaft.

Although a single sleeve bearing 54 is used, the invention should be considered as encompassing any bearing means. For example, the bearing structure may be segmented such that the overall bearing surface is provided by several discrete bearing devices. For example, a series of individual axially spaced-apart ring-type bearings may be employed instead of the single sleeve bearing design to provide a compound bearing structure.

Housing 52 can be made of any suitable material and constructed in any conventional manner known to those skilled in the art. Furthermore, housing 52 is preferably manufactured as a single solid body that is subsequently machined to create the central rod-receiving bore and the annular end grooves, for example. However, housing 52 can be constructed from individual segments that are assembled and joined together, such as two semicircular half portions. Any suitable finishing process can be used to prepare the housing surfaces for receiving the seals and bearing 54.

In one alternate configuration, the bearing structure is defined by a suitable portion of the housing, instead of being provided as a separate discrete element joined to the housing body.

Bearing 54 can be made with any suitable material. For example, bearing 54 can be made of steel, bronze, metallic, or polymer-based (e.g., a polymer matrix with fillers).

Additionally, the seals discussed herein can be made of any suitable material or composition to promote and facilitate a sealing action, preferably under high pressure. For example, a compressible material such as PTFE can be used. The seals may also be formed of an elastomeric material. Any suitable conventional process can be used to manufacture and form the seals, as known to those skilled in the art. Moreover, suitable sealing technology can be used to develop specified compressive properties in the seals, such as greater or less resilience and pressure-sensitivity.

Although the illustrated cartridge seal assembly employs grooves to locate the annular seals, it should be understood that the invention may employ a non-grooved housing that deploys one or both (or any) annular seals entirely at respective single flat planar surfaces. For this purpose, the housing ends would employ flat planar surfaces.

In this form, respecting first seal 56, it is seen that the finger and lip portions of the static sealing area would extend not from the distal end of the upper leg portion as in FIG. 2, but would instead extend from the axially innermost section of the seal body portion. A combination of groove and non-groove ends could also be employed and the selection then made between seal 56 and seal 58 as to which housing end will receive which seal. The relationship of the finger portion and lip portion to one another would otherwise remain the same, and thus the static sealing area would appear the same but in a different location relative to FIG. 2.

Alternately, respecting first seal 56, a different groove design can be employed in which the cantilever or ledge portion is removed and the housing is further machined axially inward across the same radial extent as the removed cantilever until a radially outward surface groove is formed. In this form, the finger and lip portions of the static sealing area would be disposed axially inward of the seal body portion, requiring an intermediate axially extending connection member to connect the finger portion to the main body of the seal. The relationship of the finger portion and lip portion to one another would otherwise remain the same, and thus the static sealing area would appear the same but in a different location relative to FIG. 2.

Returning to FIG. 2, with continuing reference to FIG. 3, the illustrated first annular seal member 56 includes an inner radial portion (indicated generally at 100) and an outer radial portion (indicated generally at 102).

According to one descriptive form, the illustrated inner and outer radial portions 100 and 102 include an exposed or fluid-contacting surface contour comprising, in sequence, surfaces 104, 106, 108, 110, 112, 114, 116, 118 and 120. As discussed further, these surfaces are exposed to fluid contact during installation and generally form both dynamic and static sealing areas. The dynamic sealing areas refer to surface portions of the seals where relative contact-type movement occurs between the shaft and cartridge seal assembly. In particular, the cartridge seal assembly is stationary, while the shaft can rotate and/or reciprocate axially with respect thereto. Although not referenced, it should be apparent from the drawing that seal 56 also includes a non-exposed surface contour that defines the surface that joins or mates to housing 52.

Referring now to the front end of the cartridge seal assembly in FIG. 2, the exposed surface contour of seal 56 includes a first generally angled surface 104 and a second generally angled surface 106 having one end engaging one end of the first angled surface 104 to form a comparatively high pressure sealing line 122. The surface contour further includes a third generally angled surface 108 having one end engaging another end of the second angled surface 106 to form a curvature or trough portion indicated generally at 124.

The surface contour further includes a fourth generally angled surface 110 having one end engaging another end of the third angled surface 108 to form a comparatively low pressure sealing line 126. There is further provided a first generally radial surface 112 having one end engaging another end of the fourth angled surface 110. There is also provided a fifth generally angled surface 114 having one end engaging another end of the first radial surface 112, and a sixth generally angled surface 116 having one end engaging another end of the fifth angled surface 114 to form a generally inward concave portion indicated generally at 128.

The surface contour further includes a second generally radial surface 118 having one end engaging another end of the sixth angled surface 116. As shown, the second radial surface 118 extends generally radially along an axially-directed end face 130 of housing 52. The surface contour further includes a terminal surface 120 having one end engaging another end of the second radial surface 118.

The illustrated contour geometry possesses various notable and advantageous features that result from the seal design and configuration. For purposes of discussion, reference is made to dashed reference lines 132 and 134. Reference line 132 represents the axially-extending plane of the outer radial surface 136 of housing 52. Reference line 134 represents the axially-extending plane of the inner diameter surface of the cartridge seal assembly, i.e., the plane of bearing surface 70 of bearing 54.

According to a preferred feature, housing 52 and the sealing arrangement (specifically, seal member 56) are dimensioned to facilitate a sealing engagement between the radially outermost surface of housing 52 and the opposing interior surface of the field device, e.g., the inner diameter surface of cylinder 14 of FIG. 1. As a result, a circumferential seal is established between the outer diameter (OD) surface of housing 52 and the inner diameter (ID) surface of the field device.

More specifically, seal 56 generally defines a static sealing area including second radial surface 118 and terminal surface 120. As shown, terminal surface 120 preferably extends through and radially outward of axial plane 132. As a result, seal 56 includes a radially outermost portion (indicated generally at 140) that is disposed radially outward of the outer diameter surface 136 of housing 52. In a further preferred form, axial plane 132 is associated with the radially outermost surface of housing 52, as in the drawing. The terminal surface 120 preferably extends along the peripheral or corner edge of housing 52 (located at the intersection of the radial and axial housing surfaces proximate thereto), and further extends axially along the outer surface 136 of housing 52 in a curl-back or wrap-around fashion, for example.

The benefit of forming a seal element such as 140 extending radially outward from the outermost surface 136 of housing 52 is apparent during installation. In particular, the cartridge seal assembly is constructed such that its outermost diameter defined at the apex of terminal surface 120 exceeds (by an appropriate amount) the inner diameter of the interior space in the field system unit that receives the cartridge. For example, in a piston-cylinder application, the outermost diameter of the cartridge seal assembly exceeds the inner surface diameter of the cylinder, by an amount attributable to the circumferential seal disposed about the housing at annular terminal seal portion 120.

Of course the design must allow for suitable interfit of housing 52 into the cylinder space; accordingly, the outer diameter of housing 52 (associate with outer surface 136) will be less than the inner diameter of the cylinder. However, the outer dimensions of housing 52 and the radial dimensions of surface 120 are adapted to enable the formation of a press fit connection between seal 56 (at surface 120) and the opposing inner surface of the system unit (i.e., cylinder).

The seals are preferably made of any suitable compressible material such as PTFE or an elastomeric construction. Accordingly, when the cartridge seal assembly is inserted into the field system unit (e.g., cylinder), surface 120 contactably engages an opposing surface of the cylinder and thereby experiences compression. The now compressed radially outermost seal portion 140 consequently forms a substantially fluid-tight seal joint circumferentially about housing 52 between the radially outermost surface 136 of housing 52 and the inner surface of the system cylinder.

It should be apparent that one skilled in the art could select the appropriate housing and seal dimensions to facilitate the formation of such a circumferential seal joint. The skilled artisan could take into account, for example, the desired amount of compression and the needed clearance space between the cartridge seal assembly and the surrounding surfaces of the field unit.

The seal joint facilitated by the press fit compression of seal 56 at radially outermost surface 120 inhibits fluid communication between fluid chamber 30 (FIG. 1), for example, and the annular clearance area between housing outer surface 136 and the opposing inner surface of the cylinder. As a result, fluid is prevented from migrating along the outer surfaces of housing 52 and escaping past the cartridge seal assembly. In particular, regarding the frame of reference in FIG. 2, the seal joint eliminates axial communication of fluid from the front end to the back end (i.e., left to right) through the circumferential clearance space defined between the housing and cylinder.

Another advantage of this circumferential seal joint is that the sealing engagement is immediately present upon installation and is maintained regardless of the pressure conditions of the system, i.e., pressurized or non-pressurized modes. The seal joint may be considered a press fit connection that provides a consistent sealing action throughout the life of the system unit. The compression of the circumferential seal joint is specially adapted to withstand the axially-directed hydraulic pressures that are applied during high pressure conditions. For this purpose, the geometry of the seal joint is constructed with a view towards presenting a highly pressure-resistant and resilient sealing surface.

Referring again to seal 56, this component generally defines a dynamic sealing area at a generally radially inward-facing section proximate the shaft location, such as the combination of surfaces 104, 106, 108, and 110.

As shown, the juncture formed by angled surfaces 104 and 106 defines a high pressure sealing line 122 that extends radially inward through the bearing surface plane 134. Similarly, the juncture formed by angled surfaces 108 and 110 defines a low pressure sealing line 126 that likewise extends radially inward through the bearing surface plane 134, but to a point further radially inward than line 122.

Accordingly, as a shaft is positioned in the central bore of the cartridge seal assembly, the portion of seal 56 proximate line 126 will be engaged by the shaft and compressively deflected by an amount greater than that experienced by the portion of seal 56 proximate line 122. The result is a firm sealing engagement at line 126, even under low pressure conditions. The seal area proximate line 122 will also compressively deflect and contribute to the sealing engagement with the shaft, but not to the same degree as line 126 under relatively low pressure conditions. Overall, seal 56 will experience a generally radially outward compressive deflection.

This sealing engagement arising from the compression of seal 56 at lines 122 and 126 serves as a dynamic shaft seal that inhibits and/or prevents fluid communication between fluid chamber 30 (FIG. 1), for example, and the clearance space between the shaft and bearing 54. In particular, the dynamic shaft seal prevents diminishment of the oil film bearing between bearing surface 70 and the shaft.

Under relatively high pressure conditions, however, as fluid pressure is applied to seal 56 at surfaces 114 and the concave portion 128, in particular, the effect is to urge a radially inward deflection of seal 56. This fluid-induced compressive biasing is experienced especially at the dynamic shaft sealing area, where seal 56 increases its sealing engagement relative to the shaft at both lines 122 and 126.

In one notable feature, the angular separation between surfaces 104 and 106 is greater than the angular separation between surfaces 108 and 110. As a result, the juncture defined at line 122 is comparatively flatter relative to the juncture at line 126. Accordingly, under suitable high pressure conditions, it becomes possible for line 122 to more easily acquire an axial elongation of its sealing engagement with the shaft in comparison to line 126, due to its comparatively flatter profile.

In another alternative description form, seal 56 can be considered to include an annular body portion 200, an annular first lower leg portion 202 extending from body portion 200, and a second annular upper leg portion 204 extending from body portion 200. The first and second leg portions 202 and 204 generally define a Y-shaped cross-sectional configuration. As shown, the first leg portion 202 includes the dynamic sealing area discussed above at a radially inner side thereof.

Seal 56 further includes an annular finger portion 206 having a proximal end and a distal end, and an annular terminal lip portion 208 defining (at least in part) a radially outer end of seal 56. The finger portion 206 engages the second leg portion 204 at its proximal end and extends towards its distal end in a generally radially outward direction along an end surface of housing 52, such as the indicated axially-facing surface 130 proximate second seal radial surface 118.

The terminal lip portion 208 extends from the distal end of finger portion 206 at least radially outwardly past plane 132. Preferably, lip portion 208 extends axially along outer housing surface 136 a sufficient amount to facilitate formation of a desired circumferential seal joint. As shown, in one form, finger portion 206 and lip portion 208 are located outside groove 60 (FIG. 3). Moreover, as shown, finger portion 206 and lip portion 208 include the static sealing area discussed above.

For example, it may be considered that finger portion 206 furnishes seal 56 with an axially-directed static sealing area, while lip portion 208 furnishes seal 56 with a radially-directed static sealing area. More specifically, finger portion 206 can define a static sealing area at an axially-outermost surface of the cartridge seal assembly, e.g., facing towards the high pressure end of the assembly. Additionally, lip portion 208 can define a static sealing area at a radially-outermost surface of the cartridge seal assembly, e.g., at surface 136 facing towards the opposing inner surface of the cylinder.

Referring briefly to FIG. 5, there is shown an axial end view of the fully assembled cartridge seal assembly constructed in accordance with FIG. 2, taken at the front side or high-pressure end proximate seal 56. In comparison to FIG. 4, which depicts the combined housing and bearing structure without the seals, it is apparent that seal 56 provides full coverage of the axially facing structural surfaces of the cartridge seal assembly.

In particular, the surfaces apparent from FIG. 4 are sealed as follows: bearing 54 is sealed by the dynamic seal area of seal 56 (indicated generally in FIG. 5 by disc-like annular seal portion 55); the sidewall 76 of groove 60 is sealed by the part of seal 56 contained within the groove (indicated generally in FIG. 5 by annular seal portion 57); and the end surface 130 of housing 52 is sealed by the static seal area of seal 56 at annular finger portion 206. Furthermore, as shown, the annular static seal portion defined by lip portion 208 extends circumferentially about and radially beyond the outer circumference 53 of the housing, in the manner discussed above.

Returning to FIG. 2, the illustrated cartridge seal assembly 50 further includes a second seal member 58 disposed at an end of housing 52 opposite the end carrying seal 56. For example, seal 58 would be located at the back side or low-pressure end of the cartridge seal assembly. Second seal 58 is disposed within annular groove 62 (FIG. 3).

The illustrated seal 58 generally includes a body portion 300, a wiper arm 302, and a lobe portion 304. Seal 58 generally functions as a wiping device or exclusion element that exerts a wiping action against the outer diameter surface of the piston rod shaft as it moves with respect to the cartridge seal assembly 50, i.e., axial displacement or advancement of the piston rod. The wiping device effectively retains oil within the cartridge seal assembly and protects the integrity of the thin film that needs to be present in the clearance space between bearing surface 70 and the rod outer surface.

In this manner, the rod is prevented from carrying undue amounts of a surface thin film with it as it moves out of the cartridge seal assembly. Otherwise, in the absence of such wiping activity, the thin film of oil that is continuously maintained on the rod surface will transport oil out of the assembly and thereby reduce the lubrication and thin-film bearing effects. On the return trip, as the rod is retracted or withdrawn into the cartridge seal assembly, the wiping edge of the wiper device nondestructively “scrapes” against the rod surface and acts to prevent foreign matter or debris on the rod surface from entering and being introduced into the cartridge seal assembly environment.

As known, when the rod is displaced outside its sealed environment, it is possible for debris to be attracted to the oily rod surface and become commingled with the surface oil film. However, as discussed further, since the wiping edge of the wiper device is compressively biased against the rod surface during and following rod installation, the wiper device establishes and maintains a continuous firm engagement with the rod surface that obstructs foreign surface matter from passing therethrough as the rod returns to the cartridge seal assembly.

Referring more specifically to seal 58, the illustrated wiper arm 302 extends from body 300 in a radially inward and axially outward direction. The wiper arm 302 terminates at a free end that defines a flexure tip or wiping edge portion 306. In one form, wiper arm 302 can be considered to have a fin-type cross-sectional shape, with wiping edge 306 resembling a cutting or knife-like edge.

As shown, the free end of wiper arm 302, including at least the wiping edge 306, extends radially inward past the bearing plane 134 of bearing surface 70 a sufficient amount to accommodate the seal-type wiping action. Accordingly, when the piston rod is located within the cartridge seal assembly, the piston rod will engage seal 58 at wiping edge 306 and cause the wiper arm 302 to deflect radially outward, thereby establishing a wiper-type sealing engagement between seal 58 and the rod outer surface. It is seen, for example, that this flexing action of wiper arm 302 in response to the rod insertion is facilitated by the elastomeric properties of seal 58.

Although deflected, wiper arm 302 retains a biasing property or elastic tendency that urges wiper arm 302 to return to its original undeflected form. This “snap-back” tendency of wiper arm 302 works to maintain a consistent sealing pressure against the rod surface, though clearly not enough to cause undue friction with the rod surface.

The illustrated seal 58 also includes a lobe portion 304 extending from seal body 300 and located axially inward of wiper arm 302. As shown, a lower section of lobe 304 extends radially inward past the bearing plane 134 of bearing surface 70 a sufficient amount to accommodate a sealing action. In particular, when the piston rod is located within the cartridge seal assembly, the piston rod will also engage seal 58 at lobe 304 and exert a radially outward compressive “push” that tends to flatten out lobe 304 (in the axial direction) so that a relatively broad sealing engagement is provided between seal 58 and the rod surface. As shown, lobe 304 has a proximal relationship to bearing 54 in order to promote the integrity of the sealing action vis-a-vis the thin-film clearance space between bearing surface 70 and the rod OD surface.

Regarding the overall sealing arrangement of cartridge seal assembly 50, it is seen that the dynamic sealing area of seal 56 and the sealing action of lobe 304 work in concert to provide a pair of generally annular, axially spaced-apart seals that are circumferentially disposed about the piston rod and located at opposite ends of the cartridge seal assembly.

It should be understood that the seal configuration, location, shape, and geometry shown in connection with FIG. 2 should not be considered in limitation of the present invention, as any seal system can be used. The invention can be practiced with any number of seals having any suitable shape, form, geometry, configuration, arrangement, and composition.

For example, while FIG. 2 depicts a pair of seals disposed axially of the bearing at opposite ends of the housing, it would be possible to utilize either one of the seals in combination with the bearing. Moreover, although the form of the cartridge seal assembly in FIG. 2 includes a single bearing element and a pair of seals disposed at the axial ends of the housing, it should be apparent that additional seals and bearing elements may be incorporated into this illustrated design. For example, bearing 54 could be replaced with several individual axially spaced-apart bearing members interleaved with seal members having dynamic sealing areas and/or wiping areas similar to that shown in connection with seal members 56 and 58.

Additionally, the positional relationship of the seals to the bearing may be varied. For example, the bearing device can be segmented and interleaved with suitable seals, or different numbers and types of seals can be independently arranged at both sides of the bearing device. Moreover, the same type of seals 56, 58 may be used, but located at other axial positions other than immediately next to the bearing in the indicated annular grooves.

Furthermore, the seals may be located at positions other than the ends of the housing as depicted in FIG. 2. Moreover, the seals can be located in close-ended grooves (i.e., having a single mouth), instead of the open-ended design of FIG. 2.

Seals having a variety of functions may be used. For example, while seal 56 predominantly provides a sealing function (e.g., static and dynamic sealing areas) and seal 58 predominantly supplies a wiping function, seals with other and additional functions may be used.

Although the seals depicted herein are shown as unitary structures, it may be possible to construct seals for use in the invention that are compound structures, namely, the result of integrating together and otherwise assembling several individual sealing elements into a final installation-ready seal. Any suitable conventional means known to those skilled in the art may be used for this purpose.

During installation, a cover plate or other such enclosure means is removed from the field unit (e.g., piston-cylinder device) to enable access to the interior where the cartridge seal assembly of the invention will be installed. In an application involving a piston, for example, the cartridge seal assembly is maneuvered into the cylinder housing so that the piston rod slides through the central bore defined through the assembly. Any suitable registration means or other such locating devices known to those skilled in the art may be used to fix the location of the cartridge seal assembly in the cylinder. In one form, the assembly may be seated in the cylinder until it touches an opposing surface. Any suitable attachment means may be used to lock the installed cartridge assembly into place within the field unit. Any retention means known to those skilled in the art may be used. However, the cartridge assembly is preferably removably or releasably retained in order to facilitate repair of individual parts or replacement of the entire unit.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A cartridge seal assembly, comprising:
a housing having a channel space formed therein to define an inner surface;
a bearing device joined to said housing at the inner surface thereof and having at least one bearing surface; and
at least one seal joined to said housing, at least one of said at least one seal being disposed generally axially of at least part of said bearing device.

2. The cartridge seal assembly as recited in claim 1, wherein said bearing device and/or at least one of said at least one seal being bonded to said housing.

3. The cartridge seal assembly as recited in claim 1, wherein said bearing device being fixedly mounted to said housing.

4. The cartridge seal assembly as recited in claim 1, wherein the joining relationship between said bearing device and said housing being defined by a substantially gap-free interface.

5. The cartridge seal assembly as recited in claim 1, wherein the joining interface between said housing and said bearing device being substantially free of extrusion gaps.

6. The cartridge seal assembly as recited in claim 1, wherein said at least one seal further includes:
a first generally annular seal disposed at one axial side of said bearing device, said first seal including at least one static sealing area and/or at least one dynamic sealing area.

7. The cartridge seal assembly as recited in claim 6, wherein said at least one seal further includes:
a second generally annular seal disposed at another axial side of said bearing device, said second seal including a wiper element.

8. The cartridge seal assembly as recited in claim 7, wherein one end of said housing proximal said first seal defining a high pressure end, and another end of said housing proximal said second seal defining a comparatively low pressure end.

9. The cartridge seal assembly as recited in claim 6, wherein said first seal further includes:
a body portion;
a first leg portion extending generally radially inward from said body portion;
a second leg portion extending generally radially outward from said body portion; and
a finger portion having a proximal end and a distal end, the finger portion extending generally radially outward at the proximal end thereof from said second leg portion along an end surface of said housing, the distal end defining a terminal lip having a surface extending at least in part radially outward past an axial plane of the radially outermost surface of said housing.

10. The cartridge seal assembly as recited in claim 6, wherein the at least one static sealing area of said first seal being disposed at least in part beyond a generally axially-facing surface of said housing and/or a radially outer surface of said housing.

11. The cartridge seal assembly as recited in claim 6, wherein the at least one static sealing area of said first seal further includes:
a first static sealing portion extending generally radially along a generally axially-facing end surface of said housing; and
a second static sealing portion engaging the first static sealing portion and extending at least in part immediately past the axial plane of an outer radial surface of said housing.

12. The cartridge seal assembly as recited in claim 11, wherein the second static sealing portion of said first seal being made of a compressible material and being sufficiently formed such that during operative field installation as the second static sealing portion engages an opposing surface of a field device and thereby experiences compression, the compressed second static sealing portion forms a substantially fluid-tight seal circumferentially about said housing between the outer radial surface of said housing and said field device.

13. The cartridge seal assembly as recited in claim 6, wherein the at least one dynamic sealing area of said first seal further includes:
a contoured surface extending at least in part radially inward at least to the plane of the bearing surface of said bearing device to define at least one sealing line.

14. The cartridge seal assembly as recited in claim 1, wherein said at least one seal further includes:
a first seal substantially covering a first end face of said housing and having a terminal lip portion;
said terminal lip portion extending at least immediately past an axial plane of a radially outer surface of said housing to an extent sufficient to at least touch an opposing surface of a field device during installation of said cartridge seal assembly therein.

15. The cartridge seal assembly as recited in claim 1, wherein said at least one seal further includes:
a generally annular seal portion circumferentially disposed at least in part about said housing.

16. The cartridge seal assembly as recited in claim 1, wherein said at least one seal further includes:
a first generally annular seal disposed at least in part within a first groove defined in said housing at one axial side of said bearing device; and
a second generally annular seal disposed at least in part within a second groove defined in said housing at another axial side of said bearing device.

17. The cartridge seal assembly as recited in claim 16, wherein:
said first seal includes a static sealing area and/or a dynamic sealing area; and
said second seal defining a wiper configuration.

18. The cartridge seal assembly as recited in claim 16, wherein said first groove and said second groove defining a first portion of said housing therebetween that joiningly receives said bearing device, each of said first seal and said second seal being bonded to the first housing portion.

19. The cartridge seal assembly as recited in claim 1, wherein said bearing device and/or at least one seal being removably joined to said housing.

20. A cartridge seal assembly, comprising:
a housing having a channel space formed therein to define an inner surface;
a bearing device joined to said housing at the inner surface thereof and having at least one bearing surface; and
a first generally annular seal disposed generally axially of said bearing device and joined to said housing, said first seal having a static sealing area and/or a dynamic sealing area.

21. The cartridge seal assembly as recited in claim 20, wherein at least one of said bearing device and said first seal being bonded to said housing.

22. The cartridge seal assembly as recited in claim 20, wherein said bearing device being fixedly mounted to said housing.

23. The cartridge seal assembly as recited in claim 20, wherein the joining relationship between said bearing device and said housing being defined by a substantially gap-free interface.

24. The cartridge seal assembly as recited in claim 20, wherein the joining interface between said housing and said bearing device being substantially free of extrusion gaps.

25. The cartridge seal assembly as recited in claim 20, further includes:
a second generally annular seal disposed generally axially of said bearing device and axially opposite said first seal, said second seal being joined to said housing, said second seal including a wiper element.

26. The cartridge seal assembly as recited in claim 25, wherein said bearing device being disposed at a generally axially central location of said housing, each of said first seal and said second seal being disposed in respective grooves formed in said housing at opposite sides of the housing central location and bonded to the housing at the central location thereof.

27. The cartridge seal assembly as recited in claim 20, wherein the static sealing area of said first seal further includes:
a generally annular seal circumferentially disposed at least in part about said housing.

28. The cartridge seal assembly as recited in claim 20, wherein the static sealing area of said first seal further includes:
a first static sealing portion extending generally radially along a generally axially-facing end surface of said housing; and
a second static sealing portion engaging the first static sealing portion and extending at least in part immediately past the axial plane of an outer radial surface of said housing.

29. A cartridge seal assembly, comprising:
a housing having a channel space formed therein to define an inner surface, said housing further including a first generally annular groove and a second generally annular groove defined at respective sides of said housing;
a bearing device joined to said housing at the inner surface thereof and having at least one bearing surface;
a first generally annular seal disposed at least in part within the first groove of said housing and joined thereto; and
a second generally annular seal disposed at least in part within the second groove of said housing and joined thereto.

30. The cartridge seal assembly as recited in claim 29, wherein at least one of said bearing device, said first seal, and said second seal being bonded to said housing.

31. The cartridge seal assembly as recited in claim 29, wherein at least one of said bearing device, said first seal, and said second seal being removably joined to said housing.

32. The cartridge seal assembly as recited in claim 29, wherein:
said first seal includes a static sealing area and/or a dynamic sealing area; and
said second seal including a wiper configuration.

33. The cartridge seal assembly as recited in claim 32, wherein the static sealing area of said first seal further includes:
a first static sealing portion extending generally radially along a generally axially-facing end surface of said housing; and
a second static sealing portion engaging the first static sealing portion and extending at least in part immediately past the axial plane of an outer radial surface of said housing.

34. The cartridge seal assembly as recited in claim 29, further includes:
a generally annular seal portion circumferentially disposed at least in part about said housing.

35. A cartridge seal assembly, comprising:
a housing having a receptacle channel formed therethrough;
a first means joined to said housing, said first means to define a bearing surface within the receptacle channel; and
a seal system having at least one seal, said seal system being joined to said housing.

36. The cartridge seal assembly as recited in claim 35, wherein said first means further includes:
a portion of said housing.

37. The cartridge seal assembly as recited in claim 35, wherein said first means further includes:
a bearing device joined to said housing at an inner surface defined by said receptacle channel.

38. The cartridge seal assembly as recited in claim 37, wherein said bearing device and/or at least one seal of said seal system being bonded to said housing.

39. The cartridge seal assembly as recited in claim 37, wherein the joining relationship between said bearing device and said housing being defined by a substantially gap-free interface inhibiting extrusion.

40. The cartridge seal assembly as recited in claim 35, wherein said seal system further includes:
a first generally annular seal bonded to said housing, said first seal including a static sealing area and/or a dynamic sealing area; and
a second generally annular seal bonded to said housing, said second seal including a wiper configuration.

41. The cartridge seal assembly as recited in claim 40, wherein said first means includes a bearing device bonded to said housing at an inner surface defined by said receptacle channel.

42. An apparatus, comprising:
a housing having a receptacle channel formed therethrough to define an inner housing surface;
a bearing device bonded to said housing at the inner housing surface; and
at least one seal joined to said housing.

43. The apparatus as recited in claim 42, wherein at least one of said at least one seal being bonded to said housing.

44. The apparatus as recited in claim 42, wherein the at least one seal further includes:
a first generally annular seal having a static sealing area and/or a dynamic sealing area; and
a second generally annular seal having a wiper element.

45. The apparatus as recited in claim 42, wherein the at least one seal further includes:
a seal circumferentially disposed at least in part about said housing.

46. A method of producing a cartridge seal assembly, comprising the steps of:
providing a housing having a channel space formed therethrough to define an inner surface;
bonding a bearing structure to the inner surface; and
joining at least one seal to said housing.

47. The method as recited in claim 46, wherein the joining step further includes the step of:
bonding the at least one seal to said housing.

48. A method of producing a cartridge seal assembly, comprising the steps of:
providing a housing having a channel space formed therethrough to define an inner surface;
joining a bearing structure to the inner surface to define a joining interface therebetween being substantially gap-free; and
joining at least one seal to said housing.

49. The method as recited in claim 48, wherein the step of joining the bearing structure to the housing inner surface further includes the step of:
bonding the bearing structure to said housing.
